(19) United States
(12) Patent Application Publication
(10) Pub. No.: US 2013/0069578 A1
(43) Pub. Date: Mar. 21, 2013

(54) Brushless Ceiling Fan Motor Power Control System

(71) Applicant: Kuo Tsun Lin, Taichung City (TW)

(72) Inventor: Kuo Tsun Lin, Taichung City (TW)

(73) Assignee: Chao-Chin Yao, Taichung City (TW)

(21) Appl. No.: 13/238,911

(22) Filed: Sep. 21, 2011

(51) Int. Cl. H02P 4/00

(52) U.S. Cl. 318/441

(57) ABSTRACT

A brushless ceiling fan motor power control system where the DC power input of the power distribution unit is electrically connected to a voltage boosting circuit and a voltage detecting circuit, and the voltage detecting circuit is electrically connected to the AC/DC power selecting output circuit via the first CPU, and the AC current input circuit of the power distribution unit is electrically connected to the AC/DC current power selecting output circuit.

### BACKGROUND OF THE INVENTION

1. Field of the invention

The present invention is related to a ceiling fan power control system, or more particularly to a switchable AC/DC power supply control system.

2. Brief Description of the Related Art

The ceiling fan is generally installed indoor or outdoor. When the ceiling fan is installed indoor where city power is available and therefore city power supply is more convenient while installing outdoor city power supply is inconvenient but DC power supply is more convenient, for instance, using solar DC power supply.

However, if the ceiling fan on the market uses AC power supply its controller design is AC power supply circuit; if it uses DC power supply its controller design is AC power supply circuit. Hence, if the ceiling fan using AC power supply indoor cannot use DC power supply outdoor. The present invention therefore aims to solve this problem.

### SUMMARY OF THE INVENTION

The first purpose of the present invention is to solve the aforementioned problem and provide a brushless ceiling fan motor power control system so that power input of the same ceiling fan can select AC city power supply or DC battery power supply according to different places, thereby ceiling fan can select diversified power supply and made it more convenient in applications.

The second purpose of the present invention is, while solving the aforementioned problem in providing a brushless ceiling fan motor power supply control system, to further control and conserve DC power consumption while using DC power supply in order to ensure DC power supply is not rapidly depleted.

To achieve aforementioned purposes, the present invention comprises:

a power distribution unit which include a DC power input circuit and an AC power input circuit, and the DC power input circuit is respectively and electrically connected to a power boost circuit and a power voltage detection circuit, and the power boost circuit is electrically connected to a DC power selected output circuit, and the power boost circuit provides the front input DC power supply over double voltage boost, and the power voltage detection circuit is electrically connected to the DC power selected output circuit through the first CPU, and the AC power supply circuit also electrically connected to the DC power selected output circuit, and can switch to output power as DC or AC power through the AC power input circuit.

a controller electrically connected to the rear of the power distribution unit in order to receive the selected power supply of the power distribution unit, and the controller comprises at least a rectifier and filter circuit, a CPU, a motor-driven module, a voltage reducing circuit, a zero point circuit, and a non-carbon brushless motor sensing circuit which utilizes the zero point circuit to detect the input power as AC power frequency signal, or high and low DC voltage signal, and feedback the frequency signal or the high and low voltage signal to the second CPU and the second CPU uses a feedback signal to connect the corresponding power supply.

### BRIEF DESCRIPTION OF THE DRAWINGS

FIG. 1 is a schematic diagram of circuit layout of the power distribution unit of the present invention.

FIG. 2 is a schematic diagram of the circuit layout of the controller of the present invention.

### DETAILED DESCRIPTION OF THE PREFERRED EMBODIMENTS

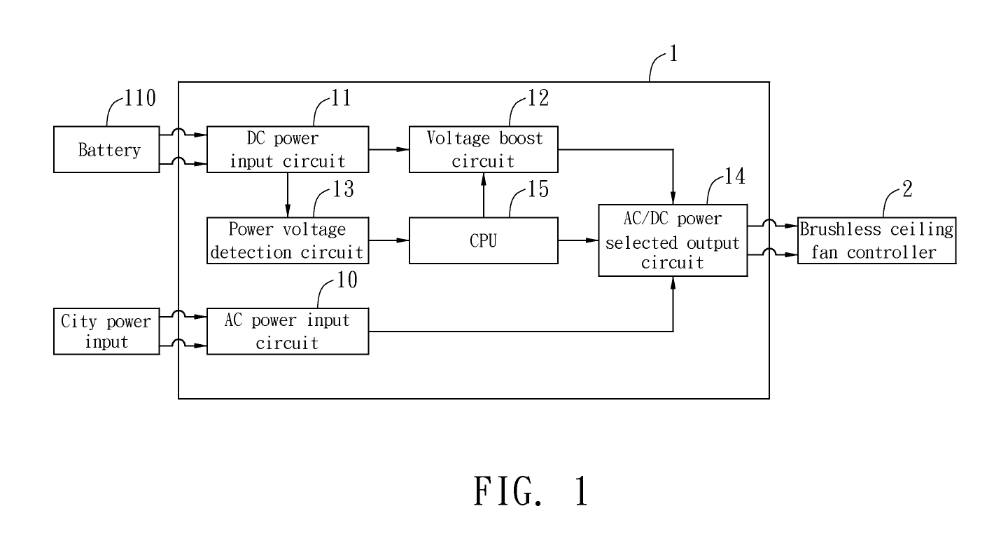

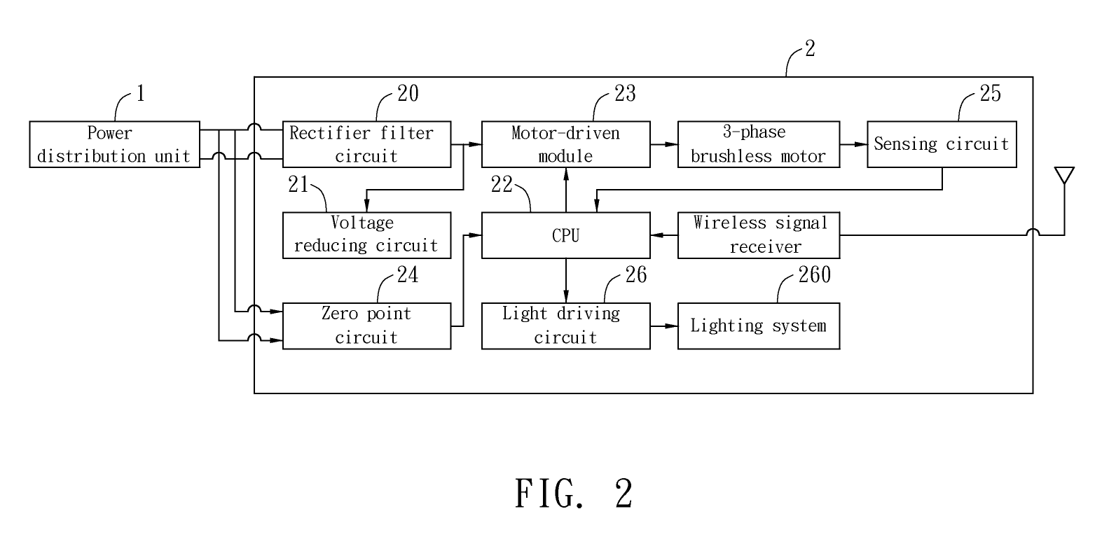

This embodiment provides a brushless ceiling fan motor power control system and the power mentioned is symbiotic of city power and DC power supply, and the embodiment comprises of a power distribution unit 1 as shown in the circuit in FIG. 1 and a controller 2 as shown in the circuit in FIG. 2 wherein:

the power distribution unit 1 comprises:

an AC power input circuit 10 for receiving AC power input and the mentioned AC power is city power input.

a DC power input circuit 11 for receiving DC power input, and the mentioned DC power in this embodiment is a battery 110 and the battery 110 in this embodiment is solar power supply.

a voltage boost circuit 12 electrically connected to the rear of the DC power input circuit 10 for doubling the front input DC power voltage. For instance, the battery DC power voltage is 24V in this embodiment and the voltage boost circuit 12 can raise its voltage to 168V, that is, a 7-fold rise of voltage in this embodiment.

a power voltage detecting circuit 13 for detecting the battery 110 voltage.

an AC/DC power selecting output circuit 14 for switching the output power into AC or DC current, and the DC power selected output circuit 14 is a relay in this embodiment. a first CPU 15 for deciding on AC or DC power output.

the controller 2 comprises:

a rectifier and filter circuit 20 which is electrically connected to the AC/DC power selecting output circuit 14 of the power distribution unit for receiving the DC non-carbon brushless motor-driven power. In this embodiment the rectifier and filter circuit 20 is electrically connected to a voltage reducing circuit 21 to provide power required by the system.

a second CPU 22 whereas this second CPU 22 has a built-in controlling program for processing the output and input signals of the controller.

a motor-driven module 23 for driving the DC non-carbon brushless motor of the ceiling fan. This motor-driven module 23 provides DC current by the rectifier and filter circuit 20, and the motor-driven module 23 and the second CPU 22 are electrically connected for delivery of control signals.

a zero point circuit 24 is serially connected to the AC/DC power selecting output circuit 14 of the power distribution unit, and also electrically connected to the second CPU 22.

a sensing circuit 25 is electrically connected to the second CPU 22 for sensing the rotation speed of the DC non-carbon brushless motor, and feedback the corresponding signal of the rotation speed to the second CPU 22.

The ceiling fan of this embodiment has a lighting system 260 which is driven by the light driving circuit 26 of the controller, and this light driving circuit 26 and the second CPU 22 are electrically connected.

In using the ceiling fan of the present invention, the user selects AC or DC power output via the first CPU 15; if DC current is selected for power supply, the voltage boosting circuit 12 would double the DC voltage of the battery 110 input, and connect to the AC/DC current selecting output circuit 14 after boosting voltage and input power into the controller 2; however, if under the DC power supply mode, when voltage detecting circuit 13 has detected battery 110 voltage is too low, then it would switch the output power supply to AC power. If the input power of the controller 2 is AC current, then use the zero point circuit 24 to detect the AC current frequency signals and feedback this frequency signal to the second CPU 22, and then the second CPU 22 would feedback the frequency signal control to the AC power supply circuit, thereby the city power would supply current to drive the ceiling fan; if the controller uses DC power input, likewise use the zero point circuit 24 to detect the high/low voltage signal of the DC current, and feedback this high/low voltage signal to the second CPU 22, and then the second CPU 22 would feedback the high/low voltage signal control to the DC power supply circuit, the ceiling fan would then be driven by DC current of the battery 110.

Hence, from aforementioned description, the present invention comprises a power distribution unit 1 for selecting AC current or DC current as the output power to the controller 2, and can select AC current or DC current as output power to the controller 2, and the controller 2 uses the zero point circuit 24 to detect the input power and feedback signal to the second CPU 22, and the second CPU 22 would control AC current circuit or DC current circuit, therefore the ceiling fan can be used indoor using city power supply and can be used outdoor using battery 110 DC power supply; therefore, the ceiling fan of the present invention can be used indoor with AC power supply or outdoor with DC power supply. This is more convenient than the conventional ceiling fan in applications.

Aside from selecting AC current of city power and DC current of battery for power supply, the ceiling fan of the present invention when operated with DC power supply it can detect high/low voltage signal with the zero point circuit 24, and the second CPU 22 receives this signal and controls the DC power supply circuit, the ceiling fan will set at the lowest rotation speed and control the light-driven circuit 26 to disable the light system 260, thereby conserving DC power consumption so as to ensure DC power would not be rapidly depleted. If the ceiling fan uses city power supply the lighting system can be controlled for action.

What is claimed is:

1. A brushless ceiling fan motor power control system, installed at a power distribution unit, comprising a DC current input circuit and an AC current input circuit, and the DC current input circuit being respectively connected to a voltage boosting circuit and a voltage detecting circuit, and the voltage boosting circuit being electrically connected to an AC/DC current selecting output circuit, and provided for a front input of a double DC current voltage, and the voltage detecting circuit being electrically connected to the AC/DC current selecting output circuit via a first CPU, and the AC current input circuit being electrically connected to the AC/DC current selecting output circuit, and switching the output power to DC or AC current via the AC current input circuit.

2. The brushless ceiling fan motor power control system of claim 1, further comprising a controller electrically connected to the rear of the power distribution unit for receiving the selected power supply of the power distribution unit; the controller comprising at least a rectifier and filter circuit, a second CPU, a motor-driven module, a voltage reducing circuit, a zero point circuit, and a DC non-carbon brushless motor sensing circuit, and the zero point circuit being used to detect the input power as an AC current frequency signal, or a high/low voltage signal of a DC current, and feedback the frequency signal or high/low voltage signal to the second CPU, and the second CPU using the feedback signal to connect to the corresponding power supply.

3. The brushless ceiling fan motor power control system of claim 2, wherein the ceiling fan has a lighting system and the controller has a light-driven circuit; if the zero point circuit has detected the input current as a high/low voltage signal of a DC current, the second CPU controls the ceiling fan to operate at the lowest rotation speed and controls the lighting system to remain idle via the light-driven circuit.

4. The brushless ceiling fan motor power control system of claim 2, wherein the AC/DC power selecting output circuit utilizes an on/off switch circuit of a relay to switch the output current to an AC or DC current.
